(19) United States
(12) Patent Application Publication
(10) Pub. No.: US 2025/0033313 A1
(43) Pub. Date: Jan. 30, 2025

(54) STRETCHABLE PACKAGING MATERIAL

(71) Applicant: Neenah Gessner GmbH, Bruckmühl (DE)

(72) Inventor: Armin Niederhuber, Bruckmühl (DE)

(21) Appl. No.: 18/782,721

(22) Filed: Jul. 24, 2024

(30) Foreign Application Priority Data
Jul. 25, 2023 (DE) 102023119650.2
Jan. 23, 2024 (EP) 24153397.5

(51) Int. Cl. B31F 1/12; B65B 11/02; D21H 11/00; D21H 19/18; D21H 19/74

(52) U.S. Cl. CPC B31F 1/12; B65B 11/025; D21H 11/00; D21H 19/18; D21H 19/74

(57) ABSTRACT

A method of producing a stretchable packaging material comprises producing a cellulose layer from a refined wood pulp, wherein the refined wood pulp has been refined to a refining degree of at least about 70° SR, and subjecting the cellulose layer to a wet creping process. A stretchable packaging material comprising a cellulose layer can be produced by this method.

### CROSS-REFERENCE TO RELATED APPLICATIONS

This application claims the benefit of foreign priority under 35 U.S.C. § 111 (a) to European patent application no. 24153397.5 filed on Jan. 23, 2024, which claims the benefit of German patent application no. 102023119650.2, filed on Jul. 25, 2023, the entire disclosures of which are incorporated herein by reference for all purposes.

### TECHNICAL FIELD

The present disclosure relates to a stretchable packaging material comprising paper and methods for making this.

### BACKGROUND

In an industrial setting, objects are commonly transported on pallets. To keep those objects bound to one another, they are typically wrapped in a plastic film, sometimes termed a stretch wrap. The plastic film is often a co-polymer of LLDPE and an alpha-olefin, although other polymers such as (pure) PE and PVC can be used. Each pallet requires a considerable amount of plastic wrap-some estimates indicate that 41 m or about 0.5 kg of plastic are required per pallet load.

There is an increasing desire to move away from plastic wrapping materials. A number of other materials have been contemplated, including paper. The attraction of paper is that it can be recycled easily and its source is sustainable. A difficulty with paper is that it typically does not stretch to any great extent and can have poor tensile strength, both of which mean that it is not that suitable for stretch wrapping. Some previous applications have mentioned the use of creped paper, e.g. US 2020/0407089, as a possible wrapping material. US 2020/0407089 describes a creped paper made for wrapping pallets using a dry creping process. However, the present inventors have found that creped paper, while having a greater elongation than some papers, can still have a relatively low elongation compared to plastic film, and also a poor tensile strength. Accordingly, it is not really suitable for use in industrial pallet wrapping machines that have been built for plastic stretch wrap materials. Its use would require a new machine or considerable adaptation of existing wrapping machines designed for use with plastic stretch wrap.

There is a desired to produce an alternative to the plastic film that is recyclable, and has an elongation and tensile strength much closer to the plastic films, such that it could be used on existing pallet wrapping machines, without the need for significant adaptation.

### SUMMARY

In a first aspect, there is provided a method of producing a stretchable packaging material, the method comprising: producing a cellulose layer from a refined wood pulp, wherein the refined wood pulp has been refined to a refining degree of at least about 70° SR; and subjecting the cellulose layer to a wet creping process.

In a second aspect, there is provided a stretchable packaging material producible using the method of the first aspect.

In a third aspect, there is provided a stretchable packaging material comprising a raw base paper; wherein the raw base paper has an elongation at break in the machine direction of at least about 8%, optionally at least about 10%, optionally at least about 12%, optionally at least about 14%; and wherein the raw base paper has a tensile strength in the machine direction of at least about 10 N/15 mm. The raw base paper may be or comprise the cellulose layer producible in the first aspect. The stretchable packaging material may be water-repellent, optionally with the raw base paper having been treated with, e.g. impregnated with, a hydrophobic substance, which may be as described herein.

In a third aspect, there is further provided a stretchable packaging material comprising a raw base paper; wherein the raw base paper has an elongation at break in the machine direction of at least about 14%; and wherein the raw base paper has a tensile strength in the machine direction of at least about 10 N/15 mm. The raw base paper may be or comprise the cellulose layer producible in the first aspect.

In a third aspect, there is further provided a stretchable packaging material comprising a raw base paper; wherein the raw base paper has an elongation at break in the machine direction of at least about 8%, optionally at least about 10%, optionally at least about 12%, optionally at least about 14%; and wherein the raw base paper has a tensile strength in the machine direction of at least about 10 N/15 mm, wherein the stretchable packaging material is water-repellent, optionally with the raw base paper having been treated with, e.g. impregnated with, a hydrophobic substance, which may be as described herein, optionally a plant wax, which may comprise a soy wax. The raw base paper may be or comprise the cellulose layer producible in the first aspect.

In a third aspect, there is further provided a stretchable packaging material comprising a raw base paper; wherein the raw base paper has an elongation at break in the machine direction of at least about 8%, optionally at least about 10%, optionally at least about 12%, optionally at least about 14%; and wherein the raw base paper has a tensile strength in the machine direction of at least about 10 N/15 mm, wherein the stretchable packaging material is water-repellent, optionally with the raw base paper having been impregnated with a hydrophobic substance comprising a plant wax, which may comprise a soy wax, and a cationic emulsifier. The raw base paper may be or comprise the cellulose layer producible in the first aspect.

In a fourth aspect, there is provided a method for packaging an object comprising: helically wrapping the object with a stretchable packaging material according to the second or third aspect.

In a fifth aspect, there is provided a device for packaging an object comprising: a device for wrapping a load with a stretchable packaging material, the device comprising a packaging material holder; and a stretchable packaging material loaded on the packaging material holder, wherein the stretchable packaging material is a material according to the second or third aspect.

### BRIEF DESCRIPTION OF THE FIGURE

FIG. 1 shows schematically a stretchable packaging material as described herein being used to bind an object.

### DETAILED DESCRIPTION

Optional and preferred features of the aspects are described below. Unless otherwise indicated, any feature can be combined with any other feature, and any aspect.

In a first aspect, there is provided a method of producing a stretchable packaging material, the method comprising producing a cellulose layer from a refined wood pulp, wherein the refined wood pulp has been refined to a refining degree of at least about 70° SR; and subjecting the cellulose layer to a wet creping process, to produce a paper, which may be termed a raw base paper or creped paper or stretch paper herein.

### Wood Pulp

The wood pulp, and the raw base paper made from the wood pulp, preferably comprises softwood fibres. Preferably, the solids content (i.e. the content of the solids, excluding water) of the refined wood pulp, and the raw base paper, comprises at least 50 wt % softwood, optionally at least 60 wt % softwood, optionally at least 70 wt % softwood, optionally at least 80 wt % softwood, optionally at least 90 wt % softwood, optionally at least 95 wt % softwood. Further woodfibres may be present, which may include hardwood fibres. Hardwood fibres may be selected from aspen, birch, beech, oak, maple, eucalyptus and gum. Optionally, the wood pulp contains 10 wt % or less hardwood, optionally 5 wt % or less hardwood, optionally 1 wt % or less hardwood, optionally no hardwood.

The wood pulp, and the raw base paper made from the wood pulp, may comprise 20 wt % or less non-wood materials, such as mineral fillers, optionally 10 wt % or less non-wood materials, optionally 5 wt % or less non-wood materials, optionally 3 wt % or less non-wood materials, optionally 2 wt % or less non-wood materials. The wood pulp, and the raw base paper made from the wood pulp, may comprise 20 wt % or less of mineral fillers, optionally 10 wt % or less of mineral fillers, optionally 5 wt % or less of mineral fillers, optionally 3 wt % or less of mineral fillers, optionally 2 wt % or less of mineral fillers. Mineral fillers include calcium carbonate, talc, clays such as kaolin, titanium dioxide, zinc oxide and calcium sulphate.

The softwood may be selected from a first woodpulp selected from Canadian NBSK and a second woodpulp selected from Scandinavian NBSK (sometimes termed Nordic NBSK). NBSK means northern bleached softwood kraft. The wood pulp, and the raw base paper, may comprise Canadian NBSK and Scandinavian NBSK. Scandinavian NBSK may comprise one or both of pine and spruce, optionally in a wt:wt ratio of about 1:10 to 10:1, optionally 5:1 to 1:5, optionally 5:1 to 1:1, optionally about 7:3. Scandinavian NBSK may comprise one or both of Scots pine and Norway spruce, sometimes in a wt:wt ratio of about 1:10 to 10:1, optionally 5:1 to 1:5, optionally 5:1 to 1:1, optionally about 7:3. Canadian NBSK may comprise Lodgepole Pine, optionally with White Spruce, and further may include wood fibres selected from the following trees: Red Cedar, Douglas fir, Hemlock, and Larch.

The softwood pulp may comprise first woodpulp, which may be a Canadian NBSK, having a fibre length of at least 2.5 mm, optionally at least 2.6 mm, optionally at least 2.7 mm, optionally at least 2.8 mm, optionally at least 2.9 mm. The first woodpulp, which may be a Canadian NBSK, may comprise a Canadian NBSK having a fibre length of from 2.5 mm to 4.2 mm, optionally from 2.6 mm to 4.0 mm, optionally from 2.7 mm to 3.5 mm. Fibre length may be measured according to FS5 ISO 16065-2.

The softwood pulp may comprise second woodpulp, which may be a Scandinavian NBSK, which may be shorter than the fibres of the second wood pulp, having a fibre length of from 1.8 mm to 3 mm, optionally from 1.8 mm to 2.5 mm, optionally from 1.9 mm to 2.5 mm. Fibre length may be measured according to FS5 ISO 16065-2.

The first wood pulp, which may be a Canadian NBSK, and the second wood pulp, which may be a Scandinavian NBSK, may present in the wood pulp, and the raw base paper, a wt:wt ratio of from 1:4 to 4:1, optionally from 4:1 to 1:1, optionally from 3:1 to 1:1, optionally from 80:20 to 60:40, optionally about 70:30. The present inventors have found that the softwood, and particularly a combination of Canadian NBSK and Scandinavian NBSK, assists in creating a paper with the desired stretch and tensile strength.

### Refining

The wood pulp is refined during the process of making the cellulose layer. Refining of wood pulp is a process of mechanically treating the fibres while suspended in a liquid such as water. The refining can be carried out in a refiner, which may be selected from a conical refiner and a disk refiner. A disk refiner has two opposing disks, between which the wood pulp is passed. On the opposing surface of each disk (i.e. the surface that faces the other disk), are bars or teeth projecting from its surface toward the other disk. During operation, one disk rotates relative to the other, and the wood pulp passes between them (and between the bars or teeth on the disks). A conical refiner is similar to a disk refiner, except that the rotating portions are in the form of cones, rather than disks. The relative rotation may be effected by one disk (or cone) rotating and the other disk (or cone) remaining stationary or both disks (or both cones) rotating in opposite directions. The wood pulp may be passed through one or more refiners to reach a desired degree of refining. Optionally, the wood pulp may be passed through a plurality of refiners arranged in series.

The refining acts to (i) increase the amount of water in the wood cells, (ii) effect fibrillation, so increasing the surface area of the fibres, and (ii) delamination of the wood cell walls.

The present inventors have found that by refining the pulp to a relatively high degree increases both the elongation of the paper and its tensile strength. The wood pulp is preferably refined to a refining degree of at least about 70° SR, optionally at least about 75° SR, optionally at least about 80° SR, optionally at least about 85° SR. The wood pulp is preferably refined to a refining degree of from 70° SR to 95° SR, optionally from 75° SR to 95° SR, optionally from 75° SR to 90° SR, optionally from 80° SR to 90° SR, optionally about 85° SR. “SR” indicates Schopper-Riegler, i.e. the Schopper-Riegler test used to measure the grinding degree of a suspension of paper fibres in water. The refining degree as determined by the Schopper-Riegler test can be measured in accordance with the procedure described in ISO 5267/1-1:1999. The wood pulp may comprise from 2 to 5 wt % solids material (the remaining wt % being water) when refining.

The cellulose layer, which may also be termed a paper or a raw base paper, may be formed from the wood pulp in a paper machine.

### Forming the Cellulose Layer

Following the refining, the refined wood pulp can be made into a cellulose layer, i.e. paper layer, in a paper making machine, and wet-creped in the paper making machine. The paper machine may be a fourdrinier paper making machine. The paper making machine may have the following sections—a forming section, a pressing section and a drying section. In the forming section, the pulp is applied to a forming fabric to allow the water from the pulp to drain through; the forming fabric may comprise a metallic or polymeric material. The refined pulp may be diluted if desired, so that it contains from 0.3 wt % to 1 wt % solids, optionally about 0.3 wt % to 0.7 wt % solids, when applied to the forming fabric. In the forming section, some of the water in the pulp runs through the forming fabric, leaving a wet cellulose layer on the forming fabric. During the press section, the cellulose layer may be passed between one or more pairs of rollers, optionally two or more, optionally three or more pairs of rollers. This presses more of the water from the cellulose layer. In the dryer section, heat is applied to the cellulose layer to effect evaporation of water. The heat may be applied by heated rollers, sometimes termed dryer drum or cans. The wet creping takes place preferably during the pressing or drying section, as long as the creping is a wet creping, i.e. the paper has a minimum amount of water as stated herein at the point of creping. The wet creping may take place on one of the pair of rollers of the press section immediately before the drying section, so, if there are three pairs of rollers in the press section, the wet creping would take place on one of the third pair of rollers. The paper making machine may have a post-processing section, e.g. to treat the cellulose layer with a substance, e.g. apply a coating substance, which may be a sizing substance and/or a hydrophobic substance, to one or both sides of the cellulose layer or impregnate the cellulose layer with a hydrophobic substance. The post-processing section may comprise a sizing press.

### Wet Creping

A creping process is a process in which the cellulose layer is compressed along its direction of travel in a paper making machine. This causes the cellulose layer to become wrinkled or creped. This may be achieved by a doctor blade, sometimes termed a creping doctor. The doctor blade may be arranged parallel to the axis of a roller or perpendicular to the direction of travel of a conveyor on which the cellulose layer is being conveyed, such that it extends across substantially the whole or at least the whole width of the paper (the width being perpendicular to the direction of movement of the cellulose layer in the paper machine). The roller may be a roller or conveyer in the press section or the drying section of a paper making machine.

A wet creping process may be considered to be a process in which the dry content (i.e. the content other than water) of the cellulose layer, measured immediately prior to the creping, is 80 wt % or less, optionally 70 wt % or less, optionally 60 wt % or less, optionally 50 wt % or less, optionally 40 wt % or less. In other words, a wet creping process may be considered to be a process in which the moisture content (i.e. the water content or content other than dry solids) of the cellulose layer, measured immediately prior to the creping, is 20 wt % or more, optionally 30 wt % or more, optionally 40 wt % or more, optionally 50 wt % or more, optionally 60 wt % or more.

Optionally, a wet creping process may be a process in which the dry content (i.e. the content other than water) of the cellulose layer, measured immediately prior to the creping, is 80 wt % to 10 wt %, optionally 70 wt % to 10 wt %, optionally 60 wt % to 10 wt %, optionally 50 wt % to 10 wt %, optionally 80 wt % to 20 wt %, optionally 70 wt % to 20 wt %, optionally 60 wt % to 20 wt %, optionally 50 wt % to 20 wt %, optionally 80 wt % to 30 wt %, optionally 70 wt % to 30 wt %, optionally 60 wt % to 30 wt %, optionally 50 wt % to 30 wt %, optionally 40 wt % to 30 wt %, optionally about 35 wt %.

Following the wet creping, the cellulose layer may be dried, for example by conveying it to a drying section of a paper making machine. The cellulose layer may be conveyed to the drying section (or if the creping is carried out in the drying section, continue to be conveyed in the drying section) on a drying felt. The drying felt may be in a slalom configuration with a plurality of heated rollers (e.g. such that on one roller, the cellulose layer directly contacts the heated roller and, on the next roller, the felt directly contacts the heater roller, or vice versa, and then alternating from roller to roller). The drying felt may comprise a monofilament fabric or a multifilament fabric. A drying felt may be a web containing apertures and formed from a non-metallic, e.g. polymeric and/or glass, material(s). The felt may be a non-woven or a woven material. The polymeric material of the felt may be selected from polyester, nylon, acrylic. In a multifilament fabric, the filament materials may be a plurality of materials selected from nylon, fibre glass, acrylic polymers. The cellulose layer is conveyed at a suitable speed and tension to ensure that it is not ripped or otherwise damaged during the drying. A lower tension will maintain the stretch and tensile strength characteristics of the cellulose layer.

The drying section may be a section in which the cellulose layer is heated to effect evaporation of water. The heat may be applied by heated rollers, sometimes termed dryer drum or cans, which may be Yankee dryers. The heated rollers may themselves be heated by steam, and, as such, may be steam drying cylinders.

Following the drying of the cellulose layer, the layer may be wound up into a roll, which may be termed a reel. The reel of cellulose layer or paper then may be loaded onto the post-processing equipment, in which the cellulose layer is unrolled, treated as desired, e.g. by application of surface sizing agent, which may include a hydrophobic polymer and/or a suitable mineral, e.g. alkyl ketene dimer, a latex and/or kaolin, to one or both sides to act as a moisture barrier/water repellant, and then wound up again into a roll, or reel, for storage. It may be cut in width as desired before or during the post-processing. The creped and dried cellulose layer may be termed a raw base paper.

The method may involve impregnation of the cellulose layer, after being subject to the wet creping process and preferably after drying, with a hydrophobic substance, e.g. a plant wax, which may be in an aqueous emulsion, optionally with a cationic emulsifier. The method of impregnation may involve applying the hydrophobic substance using a size press. The method may involve passing the cellulose layer that has been subjected to the wet creping process and drying to a size press in which hydrophobic substance is impregnated into the cellulose layer, and preferably the hydrophobic substance is applied by the size press in the form of an aqueous emulsion. If the hydrophobic substances are applied in an aqueous emulsion, after impregnation, the cellulose layer may be dried, e.g. at a raised temperature. This is described in more detail below in connection with the water repellent stretchable packaging material.

### Stretchable Packaging Material

In a second aspect, there is provided a stretchable packaging material producible using the method of the first aspect. The cellulose layer, which can be produced using the method of the first aspect, may be termed a paper or a raw base paper and it may have an elongation at break in the machine direction of at least about 8%, optionally at least about 9%, optionally at least about 10%, optionally at least about 11%, optionally at least about 12%, optionally at least about 13%, optionally at least about 14%; and/or the cellulose layer, which may be termed a paper or raw base paper, may have a tensile strength in the machine direction of at least about 10 N/15 mm.

The cellulose layer may be termed a paper or a raw base paper and it may have an elongation at break in the machine direction of at least about 14%; and/or the cellulose layer, which may be termed a paper or raw base paper, may have a tensile strength in the machine direction of at least about 10 N/15 mm.

In a third aspect, there is provided a stretchable packaging material comprising cellulose layer, which may be termed a raw base paper; wherein the cellulose layer or raw base paper has an elongation at break in the machine direction of at least about 14%; and wherein the cellulose layer or raw base paper has a tensile strength in the machine direction of at least about 10 N/15 mm.

The cellulose layer or raw base paper may have a grammage of from 10 g/m² to 150 g/m², optionally 20 g/m² to 150 g/m, optionally 20 g/m² to 120 g/m, optionally 20 g/m² to 100 g/m, optionally 20 g/m² to 80 g/m, optionally 20 g/m² to 70 g/m, optionally 30 g/m² to 60 g/m, optionally 30 g/m² to 60 g/m. The grammage may be measured according to ISO 536:2019-11.

The cellulose layer or raw base paper may have a caliper of from 0.03 mm to 0.45 mm, optionally from 0.08 mm to 0.3 mm, optionally from 0.1 mm to 0.3 mm, optionally from 0.1 mm to 0.25 mm, optionally from 0.1 mm to 0.2 mm, optionally from 0.12 to 0.17 mm, optionally from 0.13 mm to 0.17 mm, optionally from 0.14 mm to 0.15 mm. Caliper may be measured according to ISO 534:2012-02, e.g. at 10 kPa pressure.

The cellulose layer or raw base paper has a tensile strength in the machine direction of at least about 10 N/15 mm, optionally at least 15 N/15 mm, optionally at least 20 N/15 mm, optionally at least 25 N/15 mm, optionally at least 27 N/15 mm, optionally at least 30 N/15 mm. The tensile strength in the machine direction may be measured according to ISO 1924-2:2009-05.

The cellulose layer or raw base paper has a tensile strength in the cross direction of at least about 5 N/15 mm, optionally at least 7.5 N/15 mm, optionally at least 10 N/15 mm, optionally at least 12.5 N/15 mm, optionally at least 15 N/15 mm. The tensile strength in the cross direction may be measured according to ISO 1924-2:2009-05.

The cellulose layer or raw base paper may have an elongation at break in the machine direction of at least about 14%, optionally at least about 15%, optionally at least about 16%, optionally at least about 17%, optionally at least about 18%. The elongation at break in the machine direction may be measured according to ISO 1924-2:2009-05.

The cellulose layer or raw base paper may have an elongation at break in the cross direction of at least about 3%, optionally at least about 4%, optionally at least about 5%, optionally at least about 6%, optionally at least about 7%. The elongation at break in the cross direction may be measured according to ISO 1924-2:2009-05.

The cellulose layer or raw base paper may have a Gurley smoothness of from 5 s 200 ml to 50 s 200 ml, optionally from 10 s 200 ml to 30 s 200 ml, optionally from 15 s 200 ml to 25 s 200 ml. Gurley smoothness may be measured according to known standard e.g. ASTM, methods, for example ASTM D202-77.

In a fourth aspect, there is provided a method for packaging an object comprising: wrapping the object with a stretchable packaging material according to the second or third aspect. The object may be on an industrial pallet during the wrapping, and the object may be helically wrapped. If using a device for the wrapping, the device may be a wrapping machine that wraps the object. An industrial pallet may be defined as a pallet for use in industry for transporting goods. A pallet may have both width and length dimensions of from 50 cm to 150 cm, and a height less than the width and the length, e.g. from 5 to 20 cm. Some pallets come in standardised sizes, for example, an ‘English’ pallet having a length of 120 cm, a width of 120 cm and a height of 14.4 cm, a ‘Euro’ pallet having a length of 120 cm, a width of 80 cm and a height of 14.5 cm, a ‘Finpal’ having a length of 120 cm, a width of 100 cm and a height of 14.4 cm.

The stretchable packaging material (i.e. the creped paper described herein) may be on a roll for use on an industrial pallet wrap machine. The roll of stretchable packaging material (i.e. the creped paper described herein) may have a length, along its axis, of from 10 to 200 cm, optionally 30 to 150 cm, optionally 30 to 100 cm, optionally 30 to 70 cm, optionally around 50 cm.

In a fifth aspect, there is provided a device for packaging an object comprising: a device for wrapping a load with a stretchable packaging material, the device comprising a packaging material holder; and a stretchable packaging material loaded on the packaging material holder, wherein the stretchable packaging material is a material according to the second or third aspect. The device may be a machine for wrapping objects on a pallet. The device may be computer controlled. The device may have a turntable on which the pallet can sit, the turntable turning as the stretchable packaging material is wrapped on the object, and a delivery device, which dispenses the stretchable packaging material as the object is being wrapped, e.g. from a reel of the stretchable packaging material, and the delivery device may move vertically (either up or down) during the wrapping to effect a helical wrapping of the object. In an alternative embodiment, the device or part of the device, e.g. the delivery device, may rotate around the object to effect the wrapping of the stretchable packaging material on the object. The device may include a stretching means that stretches the stretchable packaging material on the object. Alternatively, the wrapping of the stretchable packaging material on the object may itself result in a stretching of the stretchable packaging material. The device may be a handheld device. The stretchable packaging material may be on a reel on the device.

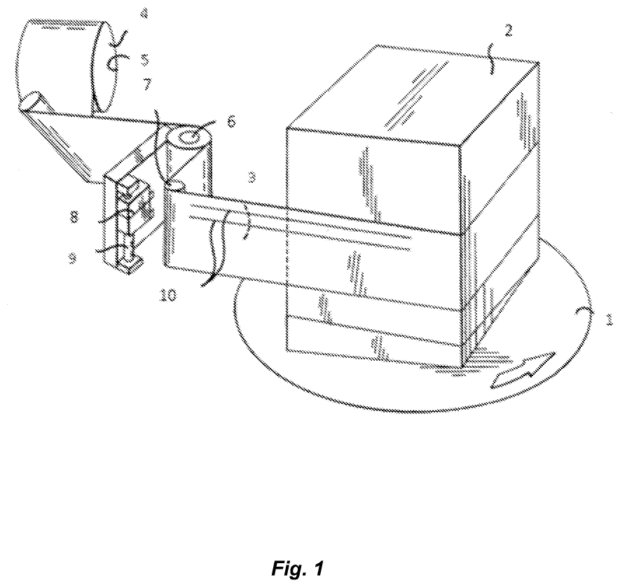

A use of the stretchable packaging material described herein is described below with reference to FIG. 1. In FIG. 1 is shown a turntable 1 having thereon an object 2 on a pallet (at the base of the object—not shown, as covered by stretchable packaging material 3). A stretchable packaging material 3 is being wound around the object 2 as the turntable turns anticlockwise. The stretchable packaging material 3 is in the form of a creped paper made in accordance with the method, and having the properties, described herein. The creped paper is fed from a reel 4 of the creped paper, the reel being mounted on a roller 5. The roller is motorised and controlled remotely to allow the speed of the feed to be suitable for the speed of rotation of the object 2 on the turntable 1, which is also remotely controlled. The creped paper is fed from the reel 4 optionally via a stretching means 6, which may be optionally present, and which is in the form of a plurality of vertical rollers having different tangential speeds, which may allow between them a stretching of the creped paper to a suitable degree. Alternatively, where a stretching means is not present, the wrapping of the creped paper on the object 1 may itself effect the stretching. The creped paper is fed from the stretching means 6 (or otherwise from the reel 4) to a delivery device 16, which is a roller than can move in the vertical direction to apply the creped paper to the appropriate level of the object 1. The creped paper 3 is typically wrapped helically around the object 1, so the delivery device will move vertically during the wrapping (upwards if the wrapping starts at the base of the object 1 or downwards if the wrapping starts at the top of the object 1). If desired, adhesive 3 may be applied to the creped paper by an adhesive application device 8, which may move on a guide rod 9. The adhesive 3 may allow the creped paper to adhere to itself during the wrapping of the object 1. However, the creped paper will typically bind to itself without the adhesive by means of the friction between layers of the creped paper and the stretch properties of the creped papers—the adhesive serves as simply as extra way of securing the paper to itself. In operation, the application of the creped paper to the object 1 may be automated, and controlled by a computer.

In an alternative embodiment, the creped paper may be applied by hand to an object, e.g. by simply wrapping a sheet of creped paper around an object by hand, or otherwise by a device that may dispense the creped paper from a roll. A hand-held device may comprise a means for accommodating a reel of the creped paper, e.g. a shaft/roller on which the reel can sit, and any other means that assist the manual application of the paper to an object, e.g. a handle to hold the device and/or a cutting means to cut the paper after it has been dispensed.

A number of standard (e.g. ASTM or ISO) measurement methods are mentioned herein. Unless otherwise specified, the most recent version of the standard measurement method, i.e. most recent up to the date of filing this application, is to be used.

Where raw base paper has been mentioned herein, “raw base paper” may also be termed a “creped paper” or “cellulose layer” or “stretch paper”.

### Water Repellent Stretchable Packaging Material

Current stretchable wrapping materials (such as plastic films) can be water repellent (also termed water resistant). Water repellent stretchable wrapping materials are advantageous as they can maintain structural integrity in wet conditions, particularly when in use for wrapping pallets for transport. The inventors of the present application developed a stretchable wrapping material comprising paper that is water repellent. Importantly, as well as being water repellent, in some embodiments, the material can maintain or improve properties desirable for a stretchable wrapping material, such as elongation tensile strength (compared to a non-water repellent stretchable packaging material). The properties of, and the methods of producing, the previously described stretch paper may also apply to the water repellent stretchable packaging material.

The inventors found that treating the cellulose layer with a hydrophobic substance resulted in a highly water-repellent stretchable material. The treating of the cellulose layer with a hydrophobic substance indicates that the cellulose layer comprises a hydrophobic substance. The hydrophobic substance may have been contacted with the fibres of the cellulose layer at any point before, during or after the formation of the cellulose layer. The hydrophobic substance may, for example, be contacted with the fibres of the cellulose layer before formation of the cellulose layer (e.g. while they are in a pulp), or after formation of the cellulose layer in a paper machine and while the cellulose layer is still wet and before the creping process, or at any other point before or after the creping process, or at any point after the creping process and before or after the paper has been dried. The treating of the cellulose layer with the hydrophobic substance may involve coating or impregnating the cellulose layer before or after the wet creping process. Preferably, the treating of the cellulose layer with the hydrophobic substance involves impregnating the cellulose layer with the hydrophobic substance after the wet creping process; the cellulose layer has preferably been dried before impregnating the cellulose layer with the hydrophobic substance. “Impregnating” the cellulose layer indicates that the hydrophobic substance is distributed, preferably homogenously, throughout the depth of the cellulose layer. Impregnating differs from coating in that coating a substance on the cellulose layer will typically result in the substance being predominantly present on the side it is coated, and not homogenously throughout the depth of the cellulose layer.

The hydrophobic substance may additionally provide good slip and non-abrasive properties to the water repellent stretchable packaging material. The cellulose layer may be treated with a hydrophobic substance in a post-processing section of a paper making machine, e.g. in a sizing press. The sizing press may be in-line (i.e. forming part of the paper making equipment that forms the cellulose layer and which carries out the creping) or off-line (i.e. separate from the paper-making equipment, so the paper can be wound onto a roll after creping and drying, and then fed from that roll at a later time to the off-line sizing press to apply the hydrophobic substance). The hydrophobic substance may be applied on one or both opposing sides of the paper, e.g. in a size press, where the two opposing sides may be defined as the surfaces of the paper in the same plane as the conveyor belt of the paper making machine. The hydrophobic substance may be applied by impregnation of the cellulose layer with the hydrophobic substance, e.g. using a size press. Impregnation may be achieved by applying the hydrophobic substance in a liquid to the cellulose layer (e.g. a liquid that is an aqueous emulsion of the hydrophobic substance), preferably when the cellulose layer is dry (and after having been subjected to creping); the liquid may be a liquid emulsion or suspension of the hydrophobic substance—preferably an aqueous liquid emulsion of the hydrophobic substance.

The hydrophobic substance, which may be impregnated into the cellulose layer as described above, may comprise a wax. The wax may be selected from a plant wax, an animal wax and a petroleum derived wax. The hydrophobic substance may comprise a plurality of waxes (a blend of waxes). The hydrophobic substance may comprise a plant-based wax and an animal-based wax. Animal and plant waxes are often biodegradable and have improved sustainability compared with petroleum-based compounds for use in treating paper, such as paraffin wax. Treating the paper with an animal or plant-based wax may improve recyclability.

The hydrophobic substance, which may be impregnated into the cellulose layer as described above, may comprise a wax, or a plurality of waxes, where the wax or waxes are selected from paraffin wax, insect wax, spermaceti, lanolin, beeswax, paraffin wax, soy wax, candelilla wax, carnauba wax (palm wax), Chinese wax, shellac wax, bayberry wax, castor wax, tallow tree wax, pea wax, rice bran wax, sugar bran wax, ouricury wax, and sunflower wax. The hydrophobic substance may comprise a plant-based wax selected from, but not limited to, lanolin, soy wax, candelilla wax, carnauba wax, bayberry wax, castor wax, tallow tree wax, pea wax, rice bran wax, sugar bran wax sunflower wax and ouricury wax. The hydrophobic substance may comprise a modified or unmodified wax. The wax is preferably a plant-based wax. The hydrophobic substance may comprise a wax which contains glycerides selected from fatty acid triglycerides, fatty acid diglycerides and fatty acid monoglycerides where hydrogenation has converted unsaturated the fatty acids in the glycerides to saturated fatty acids. The hydrophobic substance preferably comprises a plant-based wax which has undergone hydrogenation to convert unsaturated fatty acids in fatty acid glycerides (which may be glycerides selected from fatty acid triglycerides, fatty acid diglycerides and fatty acid monoglycerides) to saturated fatty acids. In other words, the hydrophobic substance may comprise unsaturated fatty acid glycerides (which may be glycerides selected from fatty acid triglycerides, fatty acid diglycerides and fatty acid monoglycerides), preferably derived from plant and/or animal wax, preferably soy wax. The hydrophobic substance may further comprise glycerides selected from unsaturated fatty acid triglycerides, unsaturated fatty acid diglycerides and unsaturated fatty acid monoglycerides.

The hydrophobic substance, which may be impregnated into the cellulose layer as described above, may comprise a soy wax. Soy wax is a vegetable wax which can be produced from soybean oil. Soy wax comprises triglycerides containing a high proportion of stearic acid (e.g. at least 50 wt %, optionally at least 60 wt %, optionally at least 70 wt %, optionally at least 80 wt % of the fatty acids in the soy oil are stearic acid; and optionally at least some of the rest of the fatty acids are palmitic). During the production of soy wax, hydrogenation converts the unsaturated fatty acids to saturated fatty acids. Soy wax is typically softer than paraffin wax, with a lower melting point. The melting point of soy wax may be from about 50° C. to about 80° C., optionally 60° C. to about 80° C., 65° C. to about 75° C. The use of a hydrophobic substance that comprises soy wax is advantageous as it is completely renewable. At least 80 wt %, optionally at least 90 wt %, of the fatty acids in the soy wax may be unsaturated. Soy wax was also found to have improved barrier properties compared to other plant waxes, and improve the tensile strength of the paper.

The hydrophobic substance, which may be impregnated into the cellulose layer as described above, may comprise a wax. The wax, which may be a plant wax (e.g. a soy wax) may have a melting point of from about 30° C. to about 150° C., optionally from about 30° C. to about 100° C., optionally from about 40° C. to about 90° C., optionally from about 50° C. to about 80° C., optionally 60° C. to about 80° C., 65° C. to about 75° C. optionally about 68, 69 or 70° C.

The hydrophobic substance, after application to (e.g. impregnation into) the cellulose layer, may be cured at a surface temperature of from about 50° C. to about 200° C., optionally from about 50° C. to about 150° C., optionally from about 60° C. to about 150° C., optionally from about 70° C. to about 150° C., optionally from about 70° C. to about 120° C., optionally from about 80° C. to about 120° C. The hydrophobic substance may be cured, after application to the cellulose layer, at a temperature above the melting point of the hydrophobic substance. If cellulose layer is wet after application of the hydrophobic substance, e.g. the hydrophobic substance is applied in an aqueous liquid (e.g. an aqueous emulsion of the hydrophobic substance) to the cellulose layer (which may have been dry before this application), then after application of the hydrophobic substance, the cellulose layer may be subjected to a drying process, e.g. by drying it at a temperature of from about 50° C. to about 200° C., optionally from about 50° C. to about 150° C., optionally from about 60° C. to about 150° C., optionally from about 70° C. to about 150° C., optionally from about 70° C. to about 120° C., optionally from about 80° C. to about 120° C. The drying process may be at a temperature at or above the melting point of the hydrophobic substance, e.g. at least 5° C., optionally at least about 10° C. above the melting point of the hydrophobic substance (e.g. the plant wax such as soy wax).

The hydrophobic substance, e.g. the plant wax such as soy wax, may be applied to (e.g. impregnated into) the cellulose layer as described above, in the form of a water-based emulsion. The water-based emulsion may comprise one or more waxes. The emulsion may comprise an emulsifier, where an emulsifier is a compound that typically has a polar portion and a non-polar portion and is typically used to generate an emulsion between hydrophobic compounds and water. The emulsifier may be selected from a non-ionic, a cationic and an anionic emulsifier, preferably a cationic emulsifier. The cationic emulsifier was found to give a far higher adhesion of the wax to the fibres of the paper and therefore a higher hydrophobicity than non-ionic and anionic emulsifiers. A cationic emulsifier may comprise a hydrocarbon chain (e.g. a C5 to C25 hydrocarbon, e.g. alkyl, chain) bonded to a quaternary ammonium group. Cationic emulsifiers may be selected from behentrimonium chloride, benzalkonium chloride, benzethonium chloride, benzododecinium bromide, carbethopendecinium bromide, cetalkonium chloride, cetrimide, cetrimonium bromide, cetrimonium chloride, cetylpyridinium chloride, didecyldimethylammonium chloride, dimethyldioctadecylammonium bromide, dimethyldioctadecylammonium chloride, diolcoyl-3-trimethylammonium propane, domiphen bromide, ethyl lauroyl arginate, lauryl methyl gluceth-10 hydroxypropyl dimonium chloride, octenidine dihydrochloride, olaflur, N-Oleyl-1,3-propanediamine, pahutoxin, stearalkonium chloride, tetramethylammonium hydroxide and thonzonium bromide. The emulsifier is present in an amount to effect emulsification of the hydrophobic substance in an aqueous liquid, which could be determined by the skilled person. The emulsifier may be a naturally occurring substance or derived from a naturally occurring substance, e.g. not made from fossil fuel resources.

In a preferred embodiment, there is provided a stretchable packaging material as described herein, in which the cellulose layer, after having been subjected to the wet creping process, has been impregnated with a hydrophobic substance, preferably a plant wax as described herein.

If the hydrophobic substance, e.g. the plant wax such as soy wax, is impregnated into the cellulose layer, the hydrophobic substance may be present in the cellulose layer in an amount of from about 1 g/m² to about 20 g/m², optionally from about 2 g/m² to about 10 g/m², optionally from about 3 g/m² to about 10 g/m², optionally from about 3 g/m² to about 7 g/m², optionally about 5 g/m².

If the hydrophobic substance is coated onto the cellulose layer, the hydrophobic substance may be coated on one side of the cellulose layer in an amount of from about 1 g/m² to about 20 g/m², optionally from about 2 g/m² to about 10 g/m², optionally from about 3 g/m² to about 10 g/m², optionally from about 3 g/m² to about 7 g/m², optionally about 5 g/m².

If the hydrophobic substance is coated onto the cellulose layer, the hydrophobic substance may be coated on both sides of the cellulose layer in an amount on each side of from about 1 g/m² to about 20 g/m², optionally from about 2 g/m² to about 10 g/m², optionally from about 3 g/m² to about 10 g/m², optionally from about 3 g/m² to about 7 g/m², optionally about 5 g/m². The hydrophobic substance may be coated in equal grammage on both sides of the cellulose layer. The hydrophobic substance may be coated in differing amounts on opposing sides of the cellulose layer.

The water repellent stretchable packaging material may have a grammage of from 10 g/m² to 150 g/m², optionally 20 g/m² to 150 g/m, optionally 20 g/m² to 120 g/m, optionally 20 g/m² to 100 g/m, optionally 20 g/m² to 80 g/m, optionally 20 g/m² to 70 g/m, optionally 30 g/m² to 60 g/m, optionally 30 g/m² to 60 g/m. The grammage may be measured according to ISO 536:2019-11 or ISO 9073-1:2023.

After treating the stretchable packaging material with the hydrophobic substance, the hydrophobic substance may constitute from about 1% to about 20% of the grammage of water repellent stretchable packaging material, optionally from about 2% to about 15%, optionally from about 5% to about 12%, optionally from about 5% to about 10%, optionally about 8%.

Cobb 60 values, which is a measurement of the amount of water that is taken up by a defined area of cellulose layer through on-sided contact with water in 60 seconds (reported in g/m²), can be used to evaluate the water repellency or water resistance of cellulose layer. For the present invention, the Cobb 60 value was measured according to DIN EN ISO 535 2014-06. The Cobb 60 value of the water repellent stretchable wrapping material may be less than 50 g/m², optionally less than 40 g/m², optionally less than 30 g/m², optionally less than 20 g/m², optionally about 15 g/m². The Cobb 60 value of the water repellent stretchable wrapping material may be from about 1 g/m² to about 50 g/m², optionally from about 2 g/m² to about 40 g/m², optionally from about 5 g/m² to about 30 g/m², optionally from about 10 g/m² to about 20 g/m².

The water repellent stretchable packaging material may have a tensile strength in the machine direction of at least about 10 N/15 mm, optionally at least 15 N/15 mm, optionally at least 20 N/15 mm, optionally at least 25 N/15 mm. The tensile strength in the machine direction may be measured according to ISO 1924-2:2009-05.

The water repellent stretchable packaging material may have a tensile strength in the cross direction of at least about 10 N/15 mm, optionally at least 5 N/15 mm, optionally at least 7.5 N/15 mm, optionally at least 10 N/15 mm, optionally at least 14 N/15 mm. The tensile strength in the machine direction may be measured according to ISO 1924-2:2009-05.

The water repellent stretchable packaging material may have an elongation at break in the machine direction of at least 7.5%, optionally at least 8%, optionally at least 9%, optionally at least 10%. The elongation at break in the machine direction may be measured according to ISO 1924-2:2009-05.

The water repellent stretchable packaging material may have an elongation at break in the cross direction of at least 5%, optionally at least 6%, optionally at least 7%, optionally at least 8%. The elongation at break in the machine direction may be measured according to ISO 1924-2:2009-05.

The water repellent stretchable packaging material may have an air permeability of at least 10 l/m²/s, optionally at least 12 l/m²/s, optionally at least 14 l/m²/s, optionally at least 16 l/m²/s. The air permeability may be measured according to ISO 9237 1995-12.

The water repellent stretchable packaging material may have a bursting strength of at least 120 kPa, optionally at least 140 kPa, optionally at least 160 kPa, optionally at least 170 kPa, optionally at least 180 kPa. The bursting strength may be measured according to DIN EN ISO 535 2014-06.

The water repellent stretchable packaging material may be used in the same manner, and with the same devices, as described above for the stretchable packaging material and cellulose layer.

### EXAMPLES

### Example 1

### Creation of Stretch Paper Using a Wet Crepe Process

In a papermaking apparatus, a blend of two types of NBSK softwood—70 wt % Canadian NBSK and 30 wt % Scandinavian NBSK—was used to make a pulp (or stock) with water in a pulper. (Before use, both types of NBSK were supplied in the form of sheets, bundled into bales.). The pulp was then stored in chests until required; the consistency (solids content) of the pulp at this point was 4 wt %. The pulp was then refined to a degree of at least 85°, as measured using the Schopper-Riegler test. The refined pulp was then diluted with water to a further to a consistency of 0.5-1 wt %, and pumped, via the headbox, to the wire section of a Fourdrinier paper making machine. The pulp then passes through the press section of the machine, passing through three nips, and, at the crepe cylinder (top roll of the 3rd press) of the third nip, creping is carried out. At that point, where creping was carried out with a doctor blade, the dry content of the pulp was about 35 wt % (i.e. about 65 wt % water), i.e. this is a wet creping process.

After the doctor blade, the paper is passed to and through the drying section via a slalom felt. In the drying section of the machine, the paper is dried with a steam heated drying cylinders (sometimes termed cans), after which it is wound up into a roll at the end of the machine.

The paper then may be loaded onto the post-processing equipment, in which the paper is unrolled, treated as desired, e.g. by application of surface sizing agent, which may include a hydrophobic polymer and/or a suitable mineral, e.g. alkyl ketene dimer, a latex and/or kaolin, to one or both sides to act as a moisture barrier/water repellant, and then wound up again into a roll, for storage. It may be cut in width as desired before or during the post-processing.

The stretch paper was measured for its various properties and these are given below in Table 1.

TABLE 1

| Property | Units | Test | Value |
|---|---|---|---|
| Grammage | [g/m²] | ISO 536: | 45 |
| | | 2019 November | |
| Caliper @ 10 kPa | [mm] | Acc. ISO 534: | 0.145 |
| | | 2012 February | |
| Tensile MD | [N/15 mm] | ISO 1924-2: | 30 |
| | | 2009 May | |
| Tensile CD | [N/15 mm] | ISO 1924-2: | 15 |
| | | 2009 May | |
| Elongation MD | [%] | ISO 1924-2: | 18 |
| | | 2009 May | |
| Elongation CD | [%] | ISO 1924-2: | 7 |
| | | 2009 May | |
| Elemendorf tear MD | [mN] | DIN EN ISO 1974: | 500 |
| | | 2012 | |
| Elemendorf tear CD | [mN] | DIN EN ISO 1974: | |
| | | 2012 | |
| Air permeability | [l/m²s] | DIN EN ISO 9237: | 35 |
| Textext | | 1995 | |
| Smoothness Gurley | [s 200 ml] | ASTM D202-77 | 21 |

It is particularly notable that the elongation in the machine direction was high, compared to other papers, at 18%. Nevertheless, the tensile strength in the machine direction was also relatively high, at 30 N/15 mm. Before the present disclosure, a combination of a high elongation and a high tensile strength was difficult to achieve. Additionally, the paper had a suitable surface roughness to provide a reasonably high-friction surface, which is useful when used as a wrapping paper.

### Example 2

### Use of Paper in an Industrial Stretch Wrap Machine

In an industrial stretch wrap machine normally used for stretch-wrapping polymeric film, the stretch wrap paper made in Example 1 was loaded as a roll in place of the typical roll of polymeric film. The apparatus was operated under the substantially same conditions as used for the polymeric film to wrap a cuboidal-shaped object on a pallet, except the draw may be slightly lower than with a polymeric film. The paper was wrapped successfully on the object on the pallet, stretching and binding onto the object (by virtue of the frictional tension between the paper layers) in the same way that a polymeric film would. This demonstrates that the stretch paper can be used in place of a polymeric film, with minimal adaption of a stretch wrap machine. Using paper as a stretch wrap means it avoids using polymeric shrink wrap, which, for environmental reasons, can be advantageous. The stretch wrap paper can be recycled after use in wrapping an object.

As well as industrial uses, such as wrapping objects on pallets, the stretch paper can be used on any other object that requires wrapping, e.g. it could be used as labeling on receptacles, with printing before or after wrapping, as desired, or to hold one or more objects together. It may be used in any setting, including a domestic setting to wrap objects and it does not require a machine to do so—it could also be done by hand.

### Example 3

### Water Repellent Stretch Paper

The inventors found that the stretch paper could be made highly water repellent by impregnating the raw paper with a cationic plant base wax (i.e. plant based wax in an emulsion with a cationic emulsifier), specifically a water-based cationic emulsion of soy wax. The water repellence of the stretch paper is beneficial such that it retains structural integrity during use. The impregnation of the soy wax resulted in a lotus effect on the surface of the material, making the stretch paper highly water repellent.

The stretch paper was made in accordance with the method described in Example 1, but with the application of the plant wax as an emulsion in a post-processing part of the equipment, i.e. after the creping process and drying of the paper, in a size press on a paper machine. This resulted in impregnation of the paper with the plant wax. After impregnation, the paper was dried at a temperature of from 80° C.-110° C. As well as drying, this temperature has the effect of curing the wax—the wax melts around the fibres and coats them to achieve maximum hydrophobicity, and serves to protects the fibres. The cationic emulsifier also has the effect of promoting adhesion of the wax to the anionic surface of the fibres.

The water repellent stretch paper was measured for its various properties and these are given below in Table 2. Comparative tests with the non-hydrophobic impregnated stretch paper are also provided. Four samples of each of the un-impregnated paper and the water-repellent stretch paper were analysed for each property. The average for the four samples is given in the table.

TABLE 2

| | | | Water | |
|---|---|---|---|---|
| | | | repellent | Un- |
| | | | stretch | impregnated |
| | Unit | Test method | paper | Paper |
| Grammage | g/m² | IOS 536 | 49 | 45 |
| | | 2019 November | | |
| Air | l/m²/s | ISO 9237 | 17.90 | 21.80 |
| permeability | | 1995 December | | |
| Caliper @ | mm | DIN EN ISO 534 | 0.15 | 0.14 |
| 10 kPa | | 2012 February | | |
| Tensile MD | N/15 mm | ISO 1924-2 | 37.88 | 36.58 |
| | | 2009 May | | |
| Tensile CD | N/15 mm | ISO 1924-2 | 15.48 | 15.43 |
| | | 2009 May | | |
| Elongation | % | ISO 1924-2 | 9.80 | 18.50 |
| MD | | 2009 May | | |
| Elongation | % | ISO 1924-2 | 8.85 | 8.53 |
| CD | | 2009 May | | |
| Bursting | kPa | DIN EN ISO 2758 | 187 | 169 |
| strength | | 2014 December | | |
| Cobb 60 | g/m² | DIN EN ISO 535 | 17 | 76 |
| | | 2014 June | | |

The water resistance of the stretch paper impregnated with the soy wax was greater than that of the unimpregnated stretch paper without the hydrophobic substance. This is illustrated by the Cobb 60 values (which provides information about the water absorption capacity of a sample) where the impregnated stretch paper had a much lower Cobb 60 value of 17 g/m², compared with 76 g/m² for the unimpregnated paper. The Cobb test determines the amount of water that is taken up by a defined area of cardboard or paper through one-sided contact with water, within a certain amount of time, where Cobb 60 is when the paper is contacted with water for 60 seconds.

Whilst achieving improved water repellence, the impregnated stretch paper maintained other desirable properties. A further benefit achieved by impregnating the stretch paper is the increased tensile strength in the machine direction (37.88 N/15 mm compared to 36.58 N/15 mm). This unexpected increase in tensile strength in combination with the improved water repellence makes the stretch wrap paper more effective for use as a wrapping material.

A further water-repellent stretch paper was made using the process described above and its properties measured as given in table 3 below. As above, a raw base paper of 45 g/m², similar to that above, was impregnated with 5 g/m² of cationic soy wax.

TABLE 3

| Property | Units | Test | Value |
|---|---|---|---|
| Grammage | [g/m²] | ISO 536: 2019 November, | 50 |
| | | ISO 9073-1: 2023 | |
| Caliper @ 10 kPa | [mm] | Acc. ISO 534: | 0.15 |
| | | 2012 February | |
| Tensile strength MD | [N/15 mm] | ISO 1924-2: | 30 |
| | | 2009 May | |
| Tensile strength CD | [N/15 mm] | ISO 1924-2: | 14 |
| | | 2009 May | |
| Elongation at | [%] | ISO 1924-2: | 13 |
| break MD | | 2009 May | |
| Elongation at | [%] | ISO 1924-2: | 9 |
| break CD | | 2009 May | |
| COBB | [g/m²] | ISO 535: | 18 |
| | | 2014 June | |

The disclosure also relates to the following numbered statements.
1. A method of producing a stretchable packaging material, the method comprising producing a cellulose layer from a refined wood pulp, wherein the refined wood pulp has been refined to a refining degree of at least about 70° SR; and subjecting the cellulose layer to a wet creping process.
2. A method according to statement 1, where the refined wood pulp has been refined to a refining degree of at least about 75° SR, optionally at least about 80° SR.
3. A method according to statement 1 or statement 2, wherein the solids content of the refined wood pulp comprises at least 80 wt % softwood, optionally at least 90 wt % softwood.
4. A method according to statement 3, wherein the softwood contains Canadian NBSK and Scandinavian NBSK.
5. A method according to statement 4, wherein the Canadian NBSK and Scandinavian NBSK are present in a wt:wt ratio of from 1:4 to 4:1, optionally from 4:1 to 1:1.
6. A method according to any one of the preceding statements, wherein the dry content of the paper, immediately prior to the creping, is 70 wt % or less, optionally 50 wt % or less, optionally 40 wt % or less.
7. A method according to any one of the preceding statements, wherein, following the wet creping process, the paper is coated on at least one side with a sizing or hydrophobic substance.
8. A stretchable packaging material comprising a raw base paper; wherein the raw base paper has an elongation at break in the machine direction of at least about 14%; and wherein the raw base paper has a tensile strength in the machine direction of at least about 10 N/15 mm.
9. A stretchable packaging material comprising a raw base paper, wherein the raw base paper is or comprises a cellulose layer producible according to any one of statements 1 to 7, optionally wherein the raw base paper is as defined in statement 8.
10. The stretchable packaging material according to statement 8 or 9, wherein the raw base paper has a grammage of from 30 to 80 g/m².
11. The stretchable packaging material according to any one of statements 8 to 10, wherein the raw base paper has been formed from pulp comprising Canadian NBSK and Scandinavian NBSK, and optionally which are present in the raw base paper a wt:wt ratio of from 1:4 to 4:1, optionally from 4:1 to 1:1.
12. A method for packaging an object comprising: wrapping the object with a stretchable packaging material according to any one of statements 8 to 11.
13. A device for packaging an object comprising: a device for wrapping a load with a stretchable packaging material, the device comprising a packaging material holder; and a stretchable packaging material loaded on the packaging material holder, wherein the stretchable packaging material is a material according to 8 to 11.
14. The method of statement 12, wherein the object is on an industrial pallet during the wrapping, and the object is helically wrapped with a device according to statement 13.
15. The method of statement 14 wherein the device is a wrapping machine for wrapping stretch wrapping an object or objects on the industrial pallet.

1. A method of producing a stretchable packaging material, the method comprising:
producing a cellulose layer from a refined wood pulp, wherein the refined wood pulp has been refined to a refining degree of at least about 70° SR; and
subjecting the cellulose layer to a wet creping process.

2. A method according to claim 1, where the refined wood pulp has been refined to a refining degree of at least about 75° SR, optionally at least about 80° SR.

3. A method according to claim 1, wherein the solids content of the refined wood pulp comprises at least 80 wt % softwood, optionally at least 90 wt % softwood.

4. A method according to claim 3, wherein the softwood contains Canadian NBSK and Scandinavian NBSK.

5. A method according to claim 4, wherein the Canadian NBSK and Scandinavian NBSK are present in a wt:wt ratio of from 1:4 to 4:1, optionally from 4:1 to 1:1.

6. A method according to claim 1, wherein the dry content of the cellulose layer, immediately prior to the creping, is 70 wt % or less, optionally 50 wt % or less, optionally 40 wt % or less.

7. A method according to claim 1, wherein, following the wet creping process, the cellulose layer is treated with a sizing or hydrophobic substance.

8. A method according to claim 7, wherein the hydrophobic substance comprises a plant wax, optionally soy wax, comprising glycerides selected from unsaturated fatty acid triglycerides, unsaturated fatty acid diglycerides and unsaturated fatty acid monoglycerides.

9. A method according to claim 7, wherein the hydrophobic substance is impregnated into the cellulose layer, following the wet creping process, in a cationic emulsion.

10. A stretchable packaging material producible in accordance with the method of claim 1.

11. A stretchable packaging material according to claim 10, wherein the stretchable packaging material has an elongation at break in the machine direction of at least about 8%, optionally at least about 10%, optionally at least about 14%; and
wherein the cellulose layer has a tensile strength in the machine direction of at least about 10 N/15 mm.

12. The stretchable packaging material according to claim 11, wherein the stretchable packaging material has a grammage of from 30 to 80 g/m².

13. The stretchable packaging material according to claim 10, wherein the cellulose layer of the stretchable packaging material has been formed from pulp comprising Canadian NBSK and Scandinavian NBSK, and optionally which are present in the cellulose layer a wt:wt ratio of from 1:4 to 4:1, optionally from 4:1 to 1:1.

14. The stretchable packaging material according to claim 10, wherein the cellulose layer, before or after the wet creping process, has been treated with (i) a plant wax, optionally a soy wax, comprising glycerides selected from unsaturated fatty acid triglycerides, unsaturated fatty acid diglycerides and unsaturated fatty acid monoglycerides; and (ii) optionally a cationic emulsifier.

15. A method for packaging an object, comprising:
wrapping the object with a stretchable packaging material according to claim 10.

16. A device for packaging an object, comprising:
a device for wrapping a load with a stretchable packaging material, the device comprising a packaging material holder; and
a stretchable packaging material loaded on the packaging material holder, wherein the stretchable packaging material is a material according to claim 10.

17. The method of claim 15, wherein the object is on an industrial pallet during the wrapping, and the object is helically wrapped with a device comprising:
a device for wrapping a load with the stretchable packaging material, the device comprising a packaging material holder; and
the stretchable packaging material loaded on the packaging material holder.

18. The method of claim 17, wherein the device is a wrapping machine for stretch wrapping an object or objects on the industrial pallet.
